(19) United States
(12) Patent Application Publication
(10) Pub. No.: US 2015/0188725 A1
(43) Pub. Date: Jul. 2, 2015

(54) SECURITY AND AUTOMATION SYSTEM

(71) Applicant: Roderick Andrew Coles, Colorado Springs, CO (US)

(72) Inventor: Roderick Andrew Coles, Colorado Springs, CO (US)

(21) Appl. No.: 14/580,707

(22) Filed: Dec. 23, 2014

Related U.S. Application Data
(60) Provisional application No. 61/921,255, filed on Dec. 27, 2013.

(51) Int. Cl. H04L 12/28; G05B 15/02

(52) U.S. Cl. CPC H04L 12/2816; G05B 15/02

(57) ABSTRACT

A security and automation system that is very simple and does not require any phone or device applications is disclosed. The system simply looks for an IP/MAC address that is registered onto a local Wi-Fi network and a response to a communication, such as a ping. The presence or absence of this indicates whether the device, and hence a user with the device, is near or away, and whether the security system can be automatically armed or disarmed and whether automation components should be activated or deactivated. Using this information the system can intelligently arm or disarm the system as well as make decisions about controlling devices within the structure, such as automatically switching on lights when a user returns, or switching them off and automatically locking all the doors when the user leaves.

### CROSS-REFERENCES TO RELATED APPLICATIONS

This application claims the benefit of U.S. Provisional Application Ser. No. 61/921,255 filed on Dec. 27, 2013 titled “Security And Home Automation System” which is incorporated herein by reference in its entirety for all that is taught and disclosed therein.

### BACKGROUND

This application is directed to a security system and more particularly to a security system that is not expensive and does not have high maintenance costs.

### SUMMARY OF THE INVENTION

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof, shall include all those described in the summary of the invention, brief description of the drawings, detailed description, abstract, and claims themselves.

Disclosed is a security and automation system that is very simple and does not require any additional phone or device applications, just the ability to monitor the Wi-Fi network of the connected device. The system simply looks for an IP/MAC address to be registered onto a local network and a response to a communication, such as a ping. The presence or absence of this communication indicates whether the device, and hence, a person with the device, is home or away from home, and whether the security system can be automatically armed or disarmed. The system may also be used in an office building, a warehouse, or any other structure where automated security is desired.

### BRIEF DESCRIPTION OF THE DRAWINGS

FIG. 1 shows a diagram of the components of a security and automation system of the present invention.

FIG. 2A shows a diagram of an embodiment of the security and automation system of the present invention where a user registered device is approaching the wireless network range of a structure.

FIG. 2B shows a diagram of an embodiment of the security and automation system of the present invention where a user registered device is within the wireless network range of a structure.

FIG. 2C shows a diagram of an embodiment of the security and automation system of the present invention where a user registered device is leaving the wireless network range of a structure.

FIG. 2D shows a diagram of an embodiment of the security and automation system of the present invention where a user registered device remains within the wireless network range of a structure during a scheduled time period.

### DETAILED DESCRIPTION

The invention may be implemented as a computer process, a computing system, or as an article of manufacture such as a computer program product. The computer program product may be a computer storage medium readable by a computer system and encoding a computer program of instructions for executing a computer process.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts, applications, or modules. It will be recognized by one skilled in the art that these operations, structural devices, acts, applications, and modules may be implemented in software, firmware, special purpose digital logic, and any combination thereof without deviating from the spirit and scope of the present invention as recited within the claims attached hereto.

Referring now to the Figures, like reference numerals and names refer to structurally and/or functionally similar elements thereof, and if objects depicted in the figures that are covered by another object, as well as the tag line for the element number thereto, may be shown in dashed lines.

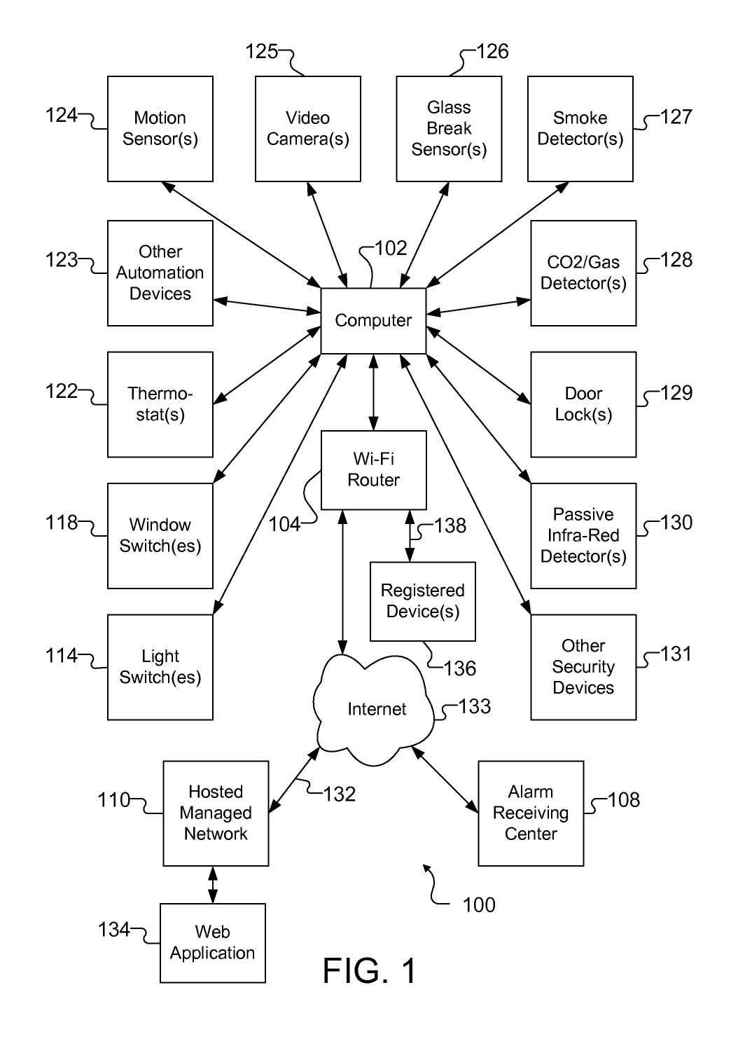

FIG. 1 shows a diagram of the components of the security and automation system of the present invention. Referring now to FIG. 1, the security and automation system 100 can be deployed in a home, an office, a warehouse, etc. The term “structure” is used herein to refer to any of these types of deployment areas. System 100 has an embedded computer 102. [Rod: is there a software program loaded on computer 102 that runs system 100? Or, does the web application run System 100, or a combination of both?]System 100 in one embodiment is based on an embedded Linux computer. However, one skilled in the art will recognize that other computers and operating systems could also be used. Computer 102 is connected to a Wi-Fi router 104. A user(s) of system 100 registers their Smartphone(s) or cellular phone(s), or any other mobile devices (e.g., Tablet, iPad, iPod, Kindle, etc.), that are collectively referred to as registered devices 136, on the Wi-Fi network connected to or provided by Wi-Fi router 104. This is done using the security protocols required by Wi-Fi router 104 and each particular registered device. System 100 will keep track of the IP/MAC address of each registered device. System 100 will constantly communicate/ping with the registered devices through Wi-Fi router 104 and wireless connection 138 to determine if the registered devices are still on the network and talking. A ping is defined as any type of IP wireless communication between any registered device 136 and system 100.

Components of system 100 fall into two general categories: security components and automation components. Security components include, but are not limited to, motion sensor(s) 124, video camera(s) 125, glass break sensor(s) 126, smoke detector(s) 127, CO₂/gas detector(s) 128, door lock(s) 129, passive infra-red detector(s) 130, and any other type of security device 131, such as water detectors, sirens, strobe lights, etc. Automation components include, but are not limited to, light switch(es) 114, window switch(es) 118, thermostat(s) 122, and any other type of automation device 123, such as RGB color changing lights, etc.

When a registered device 136 physically leaves the vicinity of the Wi-Fi range surrounding the structure, system 100 will no longer be able to communicate/ping with this IP/MAC address and it will receive a negative response, indicating that the user with the registered device has left the vicinity of the structure. System 100 will continue to try and contact that registered device 136, so when the registered device 136 comes back into Wi-Fi range and reconnects to the Wi-Fi network through wireless connection 138, then communication/pings will be positively acknowledged and system 100 will know that the user with the registered device 136 has returned to the vicinity of the structure. Using this information system 100 can intelligently arm or disarm system 100 as well as make decisions about controlling devices within the structure, such as automatically switching on light switch(es) 114 when a user returns or switching light switch(es) 114 off and automatically locking all the door lock(s) 129 when the user leaves.

System 100 can operate using any radio network that provides IP/MAC addresses of the registered devices that automatically register onto its network, such as Bluetooth, Z-wave, Zigbee, Xbee and any other suitable wireless protocol.

The automatic arming or disarming can be further controlled by the addition of a user predefined schedule, using system 100 to know whether user(s) are in the vicinity of the structure or away from the vicinity of the structure. For example, between 8:00 am and 8:00 pm, if all users with registered devices 136 have left the vicinity of the structure, then system 100 will automatically set to an Arm-Away status, which means every installed security sensor/detector is armed or activated. Between 8:00 pm and 8:00 am an Arm-Away status would be manual only (i.e., the user would have to physically arm system 100, ensuring that if a user's Smartphone died because of lack of battery power at the end of the day system 100 would not set to Arm-Away with users still in the vicinity of the structure). Physically arming system 100 can be accomplished through a web application 134 hosted on Hosted Managed Network (HMN) 110, through a Smartphone app, through a key fob, or through a control panel mounted on a wall of the structure. All of these methods access and send a command to HMN 110. The schedules, if any, are entered through web application 134 or a mobile application.

Additionally, system 100 could use the schedule to set an Arm-Stay status. In Arm-Stay status system 100 only arms the security components located on the perimeter of the structure, allowing users to move around the inside of the structure without setting off any alarms of system 100. For example, for an Arm-Stay schedule between 11:00 pm and 6:00 am, if all user(s) with registered devices are in the vicinity of the structure after 11:00 pm, then system 100 in Arm-Stay status automatically arms the security components located on the perimeter of the structure. System 100 then automatically disarms at 6:00 am in the morning. Additionally, system 100 may use a further schedule attribute to say if any users move around the structure after 5:00 am in the morning, then disarm system 100 before the normal 6:00 am time. System 100 would know this because it would be monitoring motion sensors 124 within the structure.

System 100 communicates locally over the Wi-Fi network. Computer 102 is usually connected directly to Wi-Fi router 104 and uses this mechanism to access the Wi-Fi network. System 100 ensures connectivity to the Internet 133 by monitoring the connectivity between itself and the hosted managed network 110. If this connection fails System 100 via computer 102 will reboot the Wi-Fi router 104. The power supply for the Wi-Fi router 104 is plugged into computer 102 and can automatically be switched off/on, which will fix most connectivity issues automatically.[Rod: I substituted computer 102 in some places above instead of referring to system 100. Is this more accurate?] Additional support for Xbee, Zigbee, Zwave or Bluetooth devices is available to allow third party sensors (such as window switch(es) 118, a video camera(s) 125, glass break sensor(s) 126, a smoke detector(s) 127, CO₂/gas detector(s) 128, a passive infra-red detector(s) 130, etc.) and home-automation devices (such as light switch(es) 114, thermostat(s) 122, automatic door lock(s) 129, etc.) to be connected to system 100 as shown in FIG. 1.

Communication between computer 102 and the various devices 114-131, represented by the arrows shown, may be wired, wireless, or any other suitable communications means. Communication to HMN 110 and to an Alarm Receiving Center (ARC) 108 is also via the Wi-Fi network and the Internet 133. In the event that one or more of the security sensors are set off, computer 102 sends an alarm signal to ARC 108 and based upon the type of sensor, one or more different actions may be taken by ARC 108. System 100 has a permanent TCP/IP connection 132 known as a lifeline to HMN 110 to give additional remote control of system 100 and a path to deliver alarms and signals. Permanent TCP/IP connection 132 is lightweight and will only deliver small pieces of data. If more data such as video and audio are required another on-demand connection would be made to a server at HMN 110 designed for that purpose.

The main user interface is a web application 134 hosted on HMN 110, which connects to system 100 using permanent TCP/IP connection 132, and communicates with processes directly on system 100. No user interface is needed on system 100 because this is done at HMN 110.

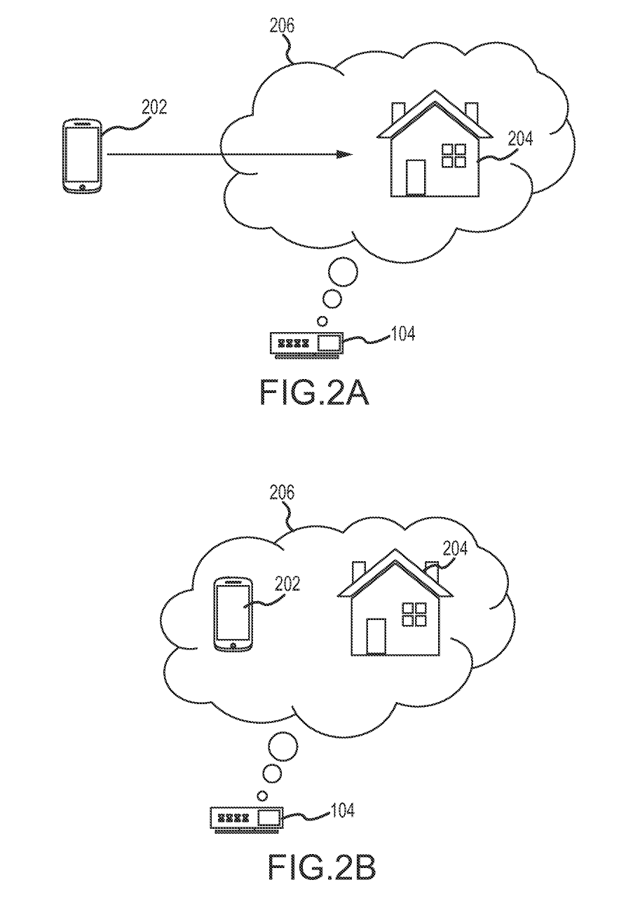

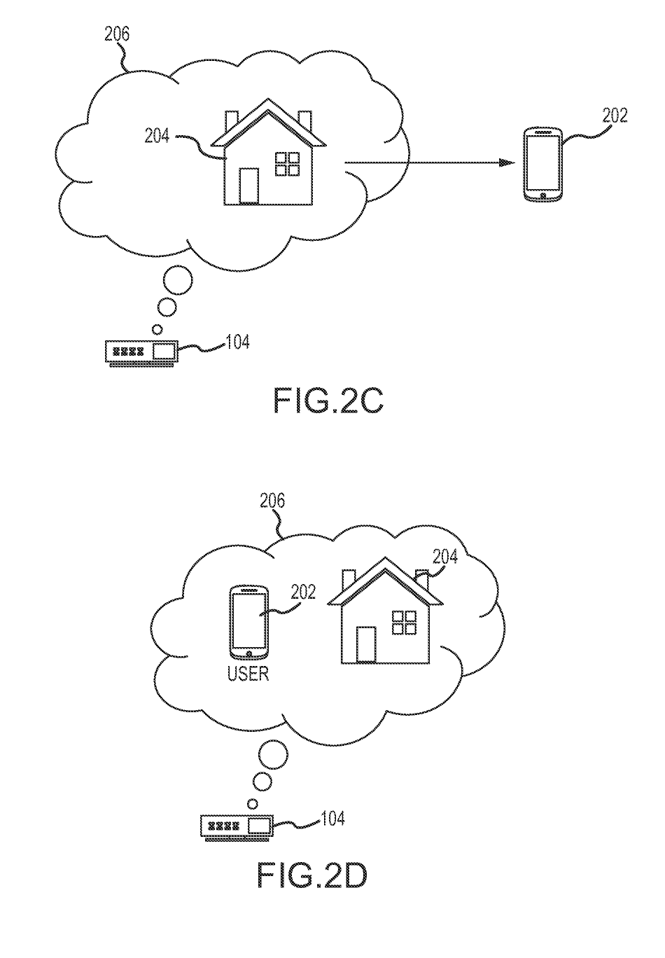

FIG. 2A shows a diagram of an embodiment of the security and automation system of the present invention where a registered device is approaching the wireless network range of a structure. Referring now to FIG. 2A, a user carrying a registered device 202 (Smartphone, cellular phone, Tablet, iPad, iPod, Kindle, etc.) approaches a secured area, such as a structure 204. The Wi-Fi range 206 of Wi-Fi router 104 typically extends beyond the exterior walls of the structure. System 100 has previously been set to the Arm-Away status, where all of the security system sensors/detectors are armed. System 100 continuously looks for the IP/MAC addresses of the registered devices on the Wi-Fi network that have been previously registered with system 100. If no addresses are found on the Wi-Fi network, the user(s) are assumed to be away and system 100 remains in the Arm-Away status. In one embodiment, System 100 checks every 10 seconds by trying to ping any registered devices 202. System 100 stays in the Arm-Away status until a successful ping is received.

FIG. 2B shows a diagram of an embodiment of the security and automation system of the present invention where a user registered device is within the wireless network range of a structure. Referring now to FIG. 2B, the user with registered device 202 is now inside the Wi-Fi range 206 around the premises of the structure 204. System 100, which has been continuously looking for the IP/MAC address of registered device 202, now finds registered device 202 on the Wi-Fi network and pings registered device 202. The ping gives positive confirmation that registered device 202 is on the network and that system 100 is not seeing a computer cache that is old. System 100 automatically upon receiving the positive ping confirmation disarms the security devices so the user can enter the structure 204 without triggering an alarm. There is no application required to reside on registered device 202. Registered device 202 is detected by its being registered onto the Wi-Fi network.

FIG. 2C shows a diagram of an embodiment of the security and automation system of the present invention where a user registered device is leaving the wireless network range of a structure. Referring now to FIG. 2C, the user with registered device 202 has left structure 204 and is now outside Wi-Fi range 206 of the Wi-Fi network. System 100 now cannot find the IP/MAC address of registered device 202 on the Wi-Fi network, and the ping fails to get a response from registered device 202. System 100 automatically sets to Arm-Away status as the user with registered device 202 has left the vicinity of structure 204. However, the rearming could take a minute or two as system 100 has to be sure the user(s) are away. In one embodiment, System 100 pings for any registered devices 202 every 10 seconds while all registered devices 202 are away. When the registered devices 202 are in the vicinity of structure 204 a successful ping will stop the check until next cycle, which in one embodiment is about every two to three seconds. However, when the registered device 202 leaves the vicinity of structure 204, system 100 has to fail to ping sixty times over about thirty seconds. This ensures that simple network failures do not give a false positive. A ping is the application layer used which uses Internet Control Message Protocol (ICMP) and is the most frequently used protocol in networking technology. A connectionless protocol, ICMP does not use any port number and works in the network layer. If there are two or more registered devices 202, system 100 will not automatically set to Arm-Away status until the last user with a registered device 202 has left the vicinity of structure 204. This whole process can be reversed for a time period that the user is expected to be in the vicinity of the structure, such as nighttime for a home structure. At night system 100 uses the same mechanism to decide if all users are in the vicinity of structure 204. If they are system 100 sets to Arm-Stay status discussed below.

FIG. 2D shows a diagram of an embodiment of the security and automation system of the present invention where a user registered device remains within the wireless network range of a structure during a scheduled time period. Referring now to FIG. 2D, at night system 100 can set to Arm-Stay status. If all the IP/MAC addresses of all of the registered devices 202 are detected, indicating that all users are in the vicinity of the structure, and within a scheduled time span, typically in the evening, system 100 can set to Arm-Stay status, where only the perimeter sensor/detectors are armed. In the morning at a predetermined time system 100 can automatically disarm, or, if motion is detected within the structure, system 100 can disarm. Should a user turn off their registered device 202 at night for recharging, a time window (10:00 pm to 5:00 am for example) can be set to prevent system 100 from setting to Arm-Away status. If the registered device 202 is left on while charging, then this time window would not be necessary.

Having described the present invention, it will be understood by those skilled in the art that many changes in construction and circuitry and widely differing embodiments and applications of the invention will suggest themselves without departing from the scope of the present invention.

What is claimed is:

1. A security and automation system located in a structure comprising:
a computer;
a Wi-Fi router connected to the computer;
at least one registered device having an IP/MAC address registered on a Wi-Fi network provided by the Wi-Fi router; and
at least one component connected to the computer;
wherein a decision to control the at least one component is made based upon the detection or lack of detection of the IP/MAC address of the at least one registered device on the Wi-Fi network.

2. The security and automation system according to claim 1 further comprising:
a hosted managed network in communication with the computer over the Internet and a permanent TCP/IP connection; and
a web application hosted on the hosted managed network;
wherein the web application provides a user interface for the security and automation system.

3. The security and automation system according to claim 1 further comprising:
an alarm receiving center in communication with the computer over the Internet;
wherein the alarm receiving center receives alarms from the computer.

4. The security and automation system according to claim 1 wherein the at least one registered device is at least one mobile device.

5. The security and automation system according to claim 4 wherein the at least one mobile device is selected from the group consisting of a Smartphone, a cellular phone, a tablet, an iPad, an iPod, and a Kindle.

6. The security and automation system according to claim 1 wherein the at least one component is selected from the group consisting of at least one security component and at least one automation component.

7. The security and automation system according to claim 6 wherein the at least one security component is selected from the group consisting of a door lock, a smoke detector, a motion sensor, a glass break sensor, a CO₂/gas detector, a water detector, a siren, and a strobe light.

8. The security and automation system according to claim 6 wherein the at least one automation component is selected from the group consisting of a passive infra-red detector, a video camera, a light switch, a window switch, a thermostat, and an RGB color changing light.

9. The security and automation system according to claim 6 further comprising:
an arm-away status, wherein all of the at least one security components are automatically activated after all of the at least one registered devices have left the vicinity of the structure at a time, and that time falls within a time window according to a predetermined schedule.

10. The security and automation system according to claim 6 further comprising:
an arm-stay status, wherein only the at least one security components located on the perimeter of the structure are automatically activated after all of the at least one registered devices have entered the vicinity of the structure at a time, and that time falls within a time window according to a predetermined schedule.

11. A method for security and automation in a structure, the method comprising the steps of:
(a) registering an IP/MAC address for at least one registered device on a Wi-Fi network provided by a Wi-Fi router connected to a computer;
(b) determining if the IP/MAC address for at least one registered device is currently registered on the Wi-Fi network; and
(c) sending a control signal to at least one component connected to the computer based upon the determination made in step (b).

12. The method for security and automation according to claim 11 further comprising the step of:
communicating from the computer over the Internet and a permanent TCP/IP connection to a hosted managed network; and
hosting a web application on the hosted managed network;
wherein the web application provides a user interface.

13. The method for security and automation according to claim 12 further comprising the steps of:
monitoring a connection to the Internet from the computer to the hosted managed network;
when the connection fails, automatically rebooting the Wi-Fi router.

14. The method for security and automation according to claim 11 further comprising the step of:
communicating from the computer over the Internet to an alarm receiving center; and
sending an alarm to the alarm receiving center when an alarm condition is detected by the computer.

15. The method for security and automation according to claim 11 wherein step (c) further comprises the steps of:
sending a control signal to at least one security component connected to the computer and to at least one automation component connected to the computer.

16. The method for security and automation according to claim 15 further comprising the step of:
entering a predefined schedule having at least one time window through the web application.

17. The method for security and automation according to claim 16 further comprising the steps of:
sending out a plurality of pings from the Wi-Fi router;
upon failing to receive any responses to the plurality of pings from the at least one registered device, determining if a current time falls within the time window from the predefined schedule; and
if yes, setting an arm-away status, wherein all of the at least one security components are automatically activated.

18. The method for security and automation according to claim 16 further comprising the steps of:
sending out a plurality of pings from the Wi-Fi router;
upon receiving responses to the plurality of pings from all of the at least one registered devices;
determining if a current time falls within the time window from the predefined schedule; and
if yes, setting an arm-stay status, wherein only the at least one security components located on the perimeter of the structure are automatically activated.

19. The method for security and automation according to claim 18 further comprising the step of:
automatically deactivating the at least one security components located on the perimeter of the structure when the time window has passed.

20. The method for security and automation according to claim 11 wherein the at least one registered device is a mobile device.
